(19) United States
(12) Patent Application Publication
(10) Pub. No.: US 2025/0322299 A1
(43) Pub. Date: Oct. 16, 2025

(54) MULTI-OBJECTIVE ORCHESTRATION OF ARTIFICIAL INTELLIGENCE MODELS

(71) Applicant: International Business Machines Corporation, Armonk, NY (US)

(72) Inventors: Aladin Djuhera, Dachau (DE); Syed Zawad, San Jose, CA (US); Fernando Luiz Koch, Palm Beach Gardens, FL (US); Alecio Pedro Delazari Binotto, Munich (DE); Martin Junghans, Karlsruhe (DE)

(21) Appl. No.: 18/635,951

(22) Filed: Apr. 15, 2024

(51) Int. Cl. G06N 20/00

(52) U.S. Cl. CPC G06N 20/00

(57) ABSTRACT

A computer-implemented method, according to one approach, includes: receiving a request for a new AI based model deployment, and determining a combination of resources that are configured to satisfy the received request. In response to determining that at least one of the resources in the combination of resources is unavailable, a determination is made as to whether resources used to form one or more existing AI based model deployments should be re-configured to satisfy the received request. Accordingly, the resources used to form the one or more existing AI based model deployments are re-configured in some instances. Moreover, the re-configured resources are re-deployed, by: forming the updated versions of the one or more existing AI based model deployments, and forming the requested new AI based model deployment.

### BACKGROUND

The present invention relates to artificial intelligence (AI) models, and more specifically, this invention relates to managing AI model deployments.

Data production continues to increase as computing power advances. For instance, the rise of smart enterprise endpoints has led to large amounts of data being generated at remote locations. Data production will only further increase with the growth of 5G networks and an increased number of connected mobile devices. As data production increases, so does the overhead associated with processing the larger amounts of data. Processing overhead is further increased when dealing with unstructured data and as different types of information are involved. For example, video and audio data may be combined in a pool of unstructured data, which results in longer processing times.

AI has been developed in an attempt to combat this rise in processing overhead. For instance, machine learning models may be used to inspect large amounts of data and draw inferences from patterns in the data. While this has reduced the amount of time that is spent analyzing data, advancements in AI and sample sizes have also continued to increase, making data processing times and overhead a continued area of focus.

Conventional applications of AI involve building rule based systems or machine learning models that are task specific. In other words, models have been developed and trained for specific assignments. While this has kept model complexity low and implementation relatively straightforward, AI models have shifted away from being configured for specific tasks. For example, in the rapidly evolving landscape of AI based workloads in edge computing, commercial and industrial organizations (e.g., in production, supply chain management, etc.) have experienced an increasing demand for AI based models that can field a wide range of prompts.

While some conventional systems have introduced foundation models in an attempt to broaden applicability, these conventional systems have struggled to support the resources associated with actually operating (e.g., using) the foundation models. This is particularly true as processing continues to be pushed from central locations out to the edge environments in an attempt to alleviate network traffic. Accordingly, there exists a need for innovative orchestration techniques that can dynamically manage multi-objective, foundation model deployments, particularly in resource-dependent environments.

### SUMMARY

A computer-implemented method (CIM), according to one approach, includes: receiving a request for a new AI based model deployment, and determining a combination of resources that are configured to satisfy the received request. In response to determining that at least one of the resources in the combination of resources is unavailable, a determination is made as to whether resources used to form one or more existing AI based model deployments should be re-configured to satisfy the received request. Accordingly, the resources used to form the one or more existing AI based model deployments are re-configured in some instances. Moreover, the re-configured resources are re-deployed, by: forming the updated versions of the one or more existing AI based model deployments, and forming the requested new AI based model deployment.

A computer program product (CPP), according to another approach, includes: a set of one or more computer-readable storage media. The CPP further includes program instructions that are collectively stored in the set of one or more storage media, and are for causing a processor set to perform any combination(s) of the foregoing methodologies.

A computer system (CS), according to yet another approach, includes: a processor set, and a set of one or more computer-readable storage media. The CS further includes program instructions that are collectively stored in the set of one or more storage media, and which are for causing the processor set to perform any combination(s) of the foregoing methodologies.

Other aspects and implementations of the present invention will become apparent from the following detailed description, which, when taken in conjunction with the drawings, illustrate by way of example the principles of the invention.

### BRIEF DESCRIPTION OF THE DRAWINGS

FIG. 1 is a diagram of a computing environment, in accordance with one approach.

FIG. 2A is a representational view of a distributed system, in accordance with one approach.

FIG. 2B is a representational view of a distributed system, in accordance with another approach.

FIG. 2C is a representational view of a process for ensuring efficient AI model deployment, in accordance with one approach.

FIG. 3A is a flowchart of a method, in accordance with one approach.

FIG. 3B is a flowchart of sub-operations for one of the operations in the method of FIG. 3A, in accordance with one approach.

### DETAILED DESCRIPTION

The following description is made for the purpose of illustrating the general principles of the present invention and is not meant to limit the inventive concepts claimed herein. Further, particular features described herein can be used in combination with other described features in each of the various possible combinations and permutations.

Unless otherwise specifically defined herein, all terms are to be given their broadest possible interpretation including meanings implied from the specification as well as meanings understood by those skilled in the art and/or as defined in dictionaries, treatises, etc.

It must also be noted that, as used in the specification and the appended claims, the singular forms “a,” “an” and “the” include plural referents unless otherwise specified. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The following description discloses several preferred approaches of systems, methods and computer program products for orchestrating AI model (e.g., foundation model) deployment across various devices. Approaches herein are thereby able to provide orchestration techniques that can dynamically manage multi-objective, resource-dependent foundation model deployments, while also ensuring efficient utilization and optimal performance for scenarios that involve the co-existence of several services and/or AI models. This is true even in dynamic deployments that may be coupled with the coexistence of multiple AI models, thereby complicating resource allocation and priority management. Approaches herein are also able to handle scenarios that involve swift model swapping in real-time, while at the same time adhering to any desired performance metrics, ensuring efficient utilization and optimal performance for scenarios that involve the co-existence of several services and/or AI based models, e.g., as will be described in further detail below.

In one general approach, a CIM includes: receiving a request for a new AI based model deployment, and determining a combination of resources that are configured to satisfy the received request. In response to determining that at least one of the resources in the combination of resources is unavailable, a determination is made as to whether resources used to form one or more existing AI based model deployments should be re-configured to satisfy the received request. Accordingly, the resources used to form the one or more existing AI based model deployments are re-configured in some instances. Moreover, the re-configured resources are re-deployed, by: forming the updated versions of the one or more existing AI based model deployments, and forming the requested new AI based model deployment.

It follows that approaches herein are able to desirably ensure dynamic resource allocation and model prioritization. For instance, approaches herein are desirably able to maintain dynamic multi-objective management by profiling current AI model deployments; and evaluating the priorities, performance metrics, and resource usage. This allows for dynamic adjustments in model configurations to meet varying objectives in an efficient manner, which has been conventionally unachievable. Approaches herein are also able to achieve resource dependent deployment strategies which evaluate the trade-offs between deploying AI models (e.g., foundation models), considering existing workloads and performance criteria. This desirably ensures efficient use of limited resources on edge devices.

In some implementations, the updated versions of the one or more existing AI based model deployments are formed by compressing the resources used to form the one or more existing AI based model deployments. Moreover, the combination of resources configured to satisfy the received request are also compressed.

Compressing AI based model deployments and/or the combinations of resources configured to actually form the deployments desirably further conserves resources. For example, in situations where there are insufficient available resources to create a new AI model, one or more existing AI model deployments may be compressed, such that at least some of the resources utilized by the uncompressed one or more existing AI model deployments become available.

In some implementations, the CIM further includes monitoring current states of the existing AI based model deployments. The current states may be monitored by gathering information associated with the current states of the existing AI based model deployments, using the information to perform capacity profiling. In some implementations, the information associated with the current states of the existing AI based model deployments is selected from the group consisting of: priority information, performance bounds, and resource utilizations. Moreover, using the information to perform capacity profiling includes outputting a prioritized list of the existing AI based model deployments and their respective current states.

It follows that implementations herein are desirably able to adapt to changing conditions by utilizing AI-driven analysis to evaluate information in real-time. Thus, approaches are able to infer future workloads and adjust priorities based on real-time data, ensuring consistent performance and resource efficiency. Moreover, advanced procedures of computing pareto-optimal capacity-performance curves for various model specifications are achieved herein, thereby streamlining the decision-making process in dynamic edge applications.

In some implementations, re-configuring the resources used to form the one or more existing AI based model deployments includes: storing the one or more existing AI based model deployments in memory. The one or more existing AI based model deployments are unloaded. Moreover, the resources from the one or more unloaded AI based model deployments are re-configured to form: the updated versions of the one or more existing AI based model deployments, and the requested new AI based model deployment. Furthermore, causing the one or more existing AI based model deployments to be stored in memory includes: storing running parameters of the one or more existing AI based model deployments.

As noted above, real-time model reconfigurations are achieved herein by dynamically redeploying re-configured (improved) AI configurations. This further allows for swift model swapping and resource reallocation, which is particularly desirable in time-sensitive operations. Approaches herein also achieve model preservation and quick redeployment by offloading models which are preserved for future use and can be quickly redeployed, maintaining operational continuity.

In some implementations, one or more of the existing AI based model deployments include multi-objective foundation models on at least one edge device. Moreover, the requested new AI based model deployment may include one or more multi-objective foundation models. It follows that in some instances, the combinations of the foregoing methodologies are performed by a central server connected to the at least one edge device. Implementations herein are thereby achieve innovative orchestration techniques that can dynamically manage multi-objective, foundation model deployments. This allows for efficient and dynamic management of AI models while satisfying workloads, which is particularly desirable in resource limited environments, e.g., such as edge nodes.

In another general approach, a CPP includes: a set of one or more computer-readable storage media. The CPP further includes program instructions that are collectively stored in the set of one or more storage media, and are for causing a processor set to perform any combination(s) of the foregoing methodologies.

In yet another general approach, a CS includes: a processor set, and a set of one or more computer-readable storage media. The CS further includes program instructions that are collectively stored in the set of one or more storage media, and which are for causing the processor set to perform any combination(s) of the foregoing methodologies.

In some implementations, a request for one or more multi-objective, AI based models is received at a central server from an edge server. The central server may thereby review various network based (e.g., network connected) resources, and determine a specific combination of resources determined as being configurable to satisfy the received request. In response to determining one or more of the resources in the specific combination are currently unavailable, a determination is made as to whether the resources in question should be made available by re-configuring one or more existing resources applications. The various network based resources may include public and/or private resources that are connected to one or more common networks, e.g., as would be appreciated by one skilled in the art after reading the present description.

Various aspects of the present disclosure are described by narrative text, flowcharts, block diagrams of computer systems and/or block diagrams of the machine logic included in computer program product (CPP) approaches. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product approach (“CPP approach” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing the inventive methods, such as improved model deployment code at block 150 for orchestrating AI model (e.g., foundation model) deployment across various devices. Approaches herein are thereby able to provide orchestration techniques that can dynamically manage multi-objective, resource-dependent foundation model deployments, while also ensuring efficient utilization and optimal performance for scenarios that involve the co-existence of several services and/or AI models, e.g., as will be described in further detail below.

In addition to block 150, computing environment 100 includes, for example, computer 101, wide area network (WAN) 102, end user device (EUD) 103, remote server 104, public cloud 105, and private cloud 106. In this approach, computer 101 includes processor set 110 (including processing circuitry 120 and cache 121), communication fabric 111, volatile memory 112, persistent storage 113 (including operating system 122 and block 150, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

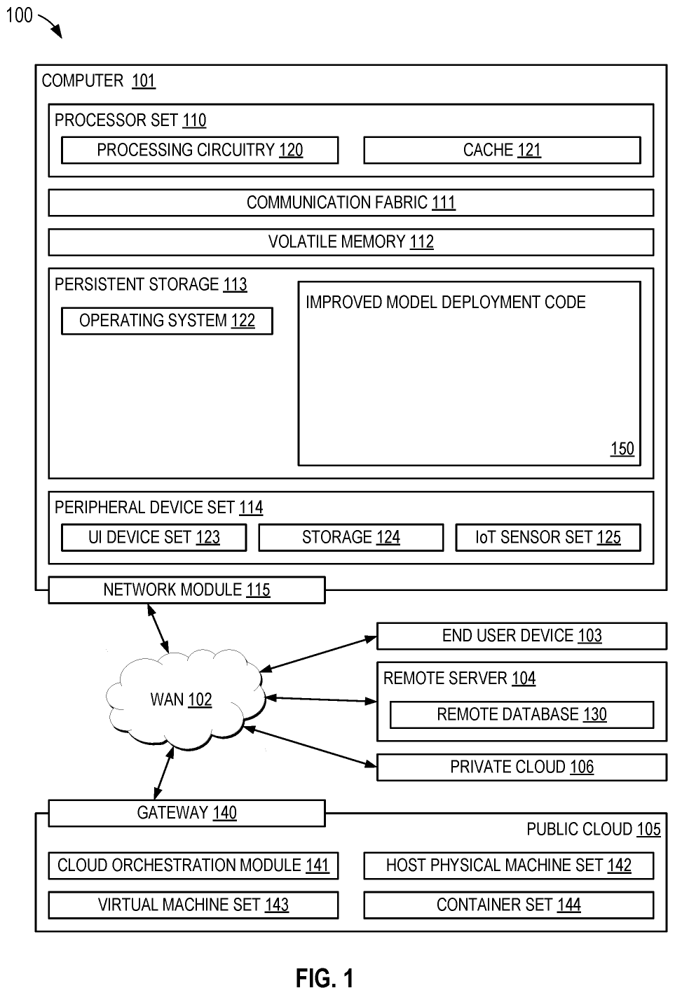

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 150 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 150 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various approaches, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some approaches, storage 124 may take the form of a quantum computing storage device for storing data in the form of qubits. In approaches where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some approaches, network control functions and network forwarding functions of network module 115 are performed on the same physical hardware device. In other approaches (for example, approaches that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some approaches, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some approaches, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other approaches a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this approach, public cloud 105 and private cloud 106 are both part of a larger hybrid cloud.

CLOUD COMPUTING SERVICES AND/OR MICROSERVICES (not separately shown in FIG. 1): private and public clouds 106 are programmed and configured to deliver cloud computing services and/or microservices (unless otherwise indicated, the word “microservices” shall be interpreted as inclusive of larger “services” regardless of size). Cloud services are infrastructure, platforms, or software that are typically hosted by third-party providers and made available to users through the internet. Cloud services facilitate the flow of user data from front-end clients (for example, user-side servers, tablets, desktops, laptops), through the internet, to the provider's systems, and back. In some approaches, cloud services may be configured and orchestrated according to as “as a service” technology paradigm where something is being presented to an internal or external customer in the form of a cloud computing service. As-a-Service offerings typically provide endpoints with which various customers interface. These endpoints are typically based on a set of application program interfaces (APIs). One category of as-a-service offering is Platform as a Service (PaaS), where a service provider provisions, instantiates, runs, and manages a modular bundle of code that customers can use to instantiate a computing platform and one or more applications, without the complexity of building and maintaining the infrastructure typically associated with these things. Another category is Software as a Service (SaaS) where software is centrally hosted and allocated on a subscription basis. SaaS is also known as on-demand software, web-based software, or web-hosted software. Four technological sub-fields involved in cloud services are: deployment, integration, on-demand, and virtual private networks.

In some aspects, a system according to various approaches may include a processor and logic integrated with and/or executable by the processor, the logic being configured to perform one or more of the process steps recited herein. The processor may be of any configuration as described herein, such as a discrete processor or a processing circuit that includes many components such as processing hardware, memory, I/O interfaces, etc. By integrated with, what is meant is that the processor has logic embedded therewith as hardware logic, such as an application specific integrated circuit (ASIC), a FPGA, etc. By executable by the processor, what is meant is that the logic is hardware logic; software logic such as firmware, part of an operating system, part of an application program; etc., or some combination of hardware and software logic that is accessible by the processor and configured to cause the processor to perform some functionality upon execution by the processor. Software logic may be stored on local and/or remote memory of any memory type, as known in the art. Any processor known in the art may be used, such as a software processor module and/or a hardware processor such as an ASIC, a FPGA, a central processing unit (CPU), an integrated circuit (IC), a graphics processing unit (GPU), etc.

Of course, this logic may be implemented as a method on any device and/or system or as a computer program product, according to various approaches.

As noted above, AI has typically involved building rule based systems or machine learning models that are task specific. In other words, models have been developed and trained for specific assignments. While this has kept model complexity low and implementation relatively straightforward, AI models have shifted away from being configured for specific tasks. For example, in the rapidly evolving landscape of AI based workloads in edge computing, commercial and industrial organizations (e.g., in production, supply chain management, etc.) have experienced an increasing demand for AI based models that can field a wide range of prompts.

While some conventional systems have introduced foundation models in an attempt to broaden applicability, these conventional systems have struggled to support the resources associated with actually operating (e.g., using) the foundation models. This is particularly true as processing continues to be pushed from central locations out to the edge environments in an attempt to alleviate network traffic. Accordingly, there exists a need for innovative orchestration techniques that can dynamically manage multi-objective, foundation model deployments, particularly in resource-dependent environments.

According to a non-limiting example, swarms of autonomous vehicles (e.g., drones, mini ships, robots, etc.) may be crucial to various missions and service tasks such as supply chain deliveries in futuristic cities like Neom in Saudi Arabia, critical hospital tasks, dynamically expanding telecom coverage at large events, etc. The autonomous vehicles may operate concurrently or in a sequence to achieve multiple parallel objectives with several different AI models employed. It follows that the challenge of deploying and managing AI foundation models significantly intensifies as complexity increases. This is particularly true on resource-constrained devices.

In sharp contrast to conventional shortcomings, approaches herein are desirably able to deploy multiple AI foundation models, even on resource-constrained devices, to satisfy a given request. This is true even in dynamic deployments that may be coupled with the coexistence of multiple AI models, thereby complicating resource allocation and priority management. Approaches herein are also able to handle scenarios that involve swift model swapping in real-time, while at the same time adhering to any desired performance metrics, ensuring efficient utilization and optimal performance for scenarios that involve the co-existence of several services and/or AI based models, e.g., as will be described in further detail below.

It should be noted that as used herein, a “foundation model” is intended to refer to any AI based model that is trained on a broad set of information such that it may be applied in multi-objective situations and across a wide range of use cases. In other words, a foundation model may be configured to perform multi-objective optimization (e.g., multi-objective programming, vector optimization, multicriteria optimization, multi-attribute optimization, etc.) in order to optimize more than one objective (e.g., parameter). This allows a foundation model to be deployed across a broad range of situations in a system without performing any additional training. In some situations, foundation models may also be used as a base (e.g., foundation) for building models that are tailored for a particular purpose. Again, because the foundation model has already developed a broad understanding of a system and the entities therein, these tailored models may be developed with minimal processing. In some situations, these tailored models may even be developed from the foundation models without performing any additional training. For instance, prompt tuning may be performed on a foundation model by simply providing a few examples along with the desired task, rather than generating and applying significant amounts of training data, e.g., as would be appreciated by one skilled in the art after reading the present description.

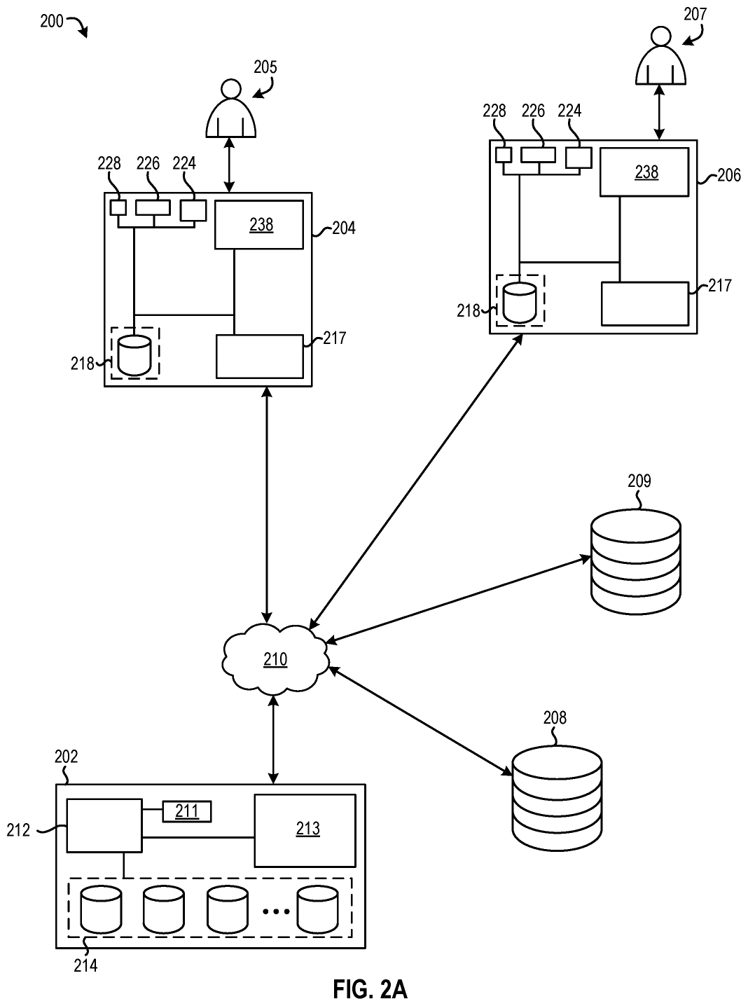

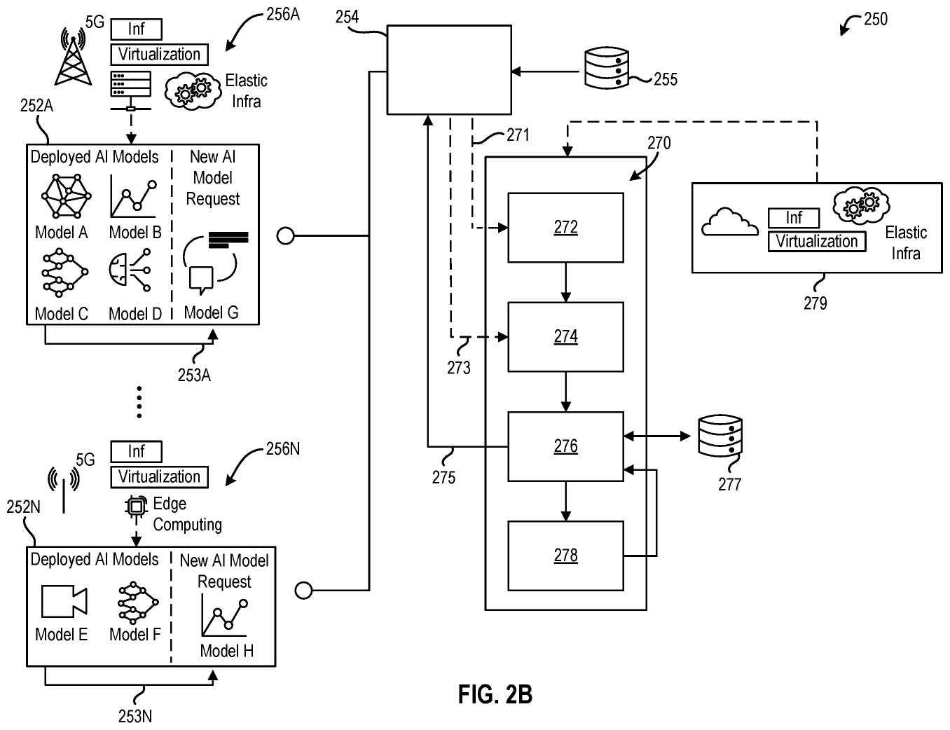

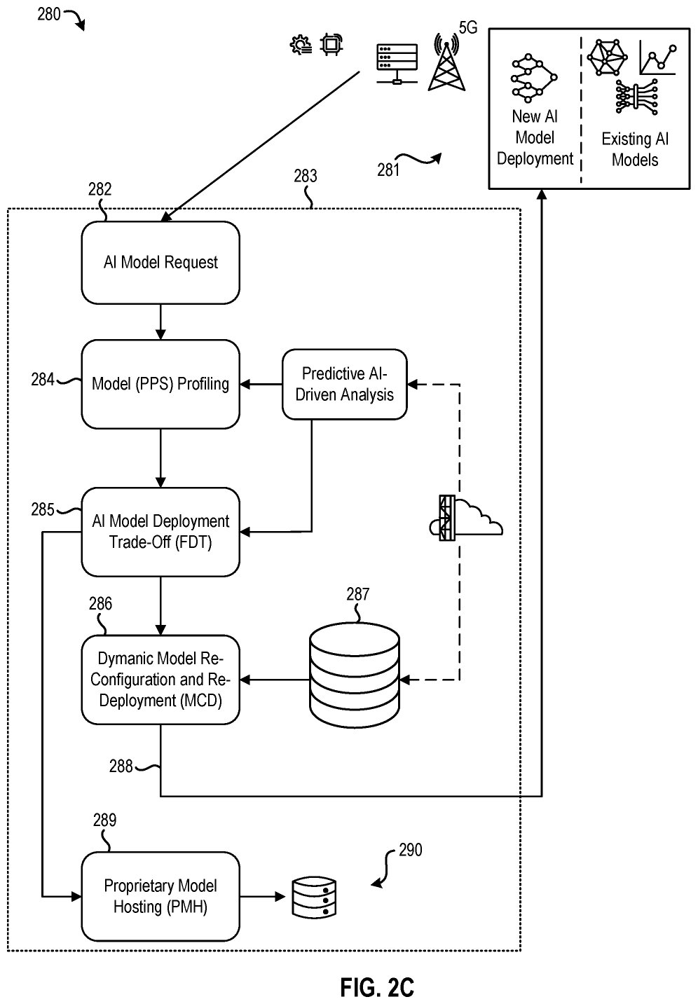

Looking now to FIG. 2A, a distributed system 200 for orchestrating AI model (e.g., foundation model) deployment, particularly on edge nodes, is illustrated in accordance with one approach. As an option, the present system 200 may be implemented in conjunction with features from any other approach listed herein, such as those described with reference to the other FIGS., such as FIG. 1. However, such system 200 and others presented herein may be used in various applications and/or in permutations which may or may not be specifically described in the illustrative approaches or implementations listed herein. Further, the system 200 presented herein may be used in any desired environment. Thus FIG. 2A (and the other FIGS.) may be deemed to include any possible permutation.

As shown, the system 200 includes a central server 202 that is connected to first and second edge nodes 204, 206 that are accessible to user 205 and administrator 207, respectively. The central server 202, is also connected to first and second databases 208, 209, each of which may be used to store one or more AI based models, e.g., as will be described in further detail below.

First and second edge nodes 204, 206 are each connected to a network 210, along with central server 202, first database 208, and second database 209, and may thereby be positioned in different geographical locations. The network 210 may be of any type, e.g., depending on the desired approach. For instance, in some approaches the network 210 is a WAN, e.g., such as the Internet. However, an illustrative list of other network types which network 210 may implement includes, but is not limited to, a LAN, a PSTN, a SAN, an internal telephone network, etc. As a result, any desired information, data, commands, instructions, responses, requests, etc. may be sent between first edge node 204, second edge node 206, central server 202, first database 208, and second database 209, regardless of the amount of separation which exists therebetween, e.g., despite being positioned at different geographical locations.

However, it should be noted that two or more of the first edge node 204, second edge node 206, central server 202, first database 208, and second database 209 may be connected differently depending on the approach. According to an example, which is in no way intended to limit the invention, two edge nodes may be located relatively close to each other and connected by a wired connection, e.g., a cable, a fiber-optic link, a wire, etc.; etc., or any other type of connection which would be apparent to one skilled in the art after reading the present description.

The terms “user” and “administrator” are in no way intended to be limiting either. For instance, while users and administrators may be described as being individuals in various implementations herein, a user and/or an administrator may be an application, an organization, a preset process, etc. The use of “data” and “information” herein is in no way intended to be limiting either, and may include any desired type of details, e.g., depending on the type of operating system implemented on the edge nodes 204, 206, databases 208, 209, and/or central server 202.

With continued reference to FIG. 2A, the central server 202 includes a large (e.g., robust) processor 212 coupled to a cache 211, an AI module 213, and a data storage array 214 having a relatively high storage capacity. As noted above, the AI module 213 may include any desired number and/or type of AI based models. In preferred approaches, the AI module 213 and/or processor 212 are configured to orchestrate AI model (e.g., foundation model) deployment on resource-constrained edge devices. In other words, approaches herein provide orchestration techniques that are able to dynamically manage multi-objective, resource-dependent foundation model deployments, while also ensuring efficient utilization and optimal performance for scenarios that involve the co-existence of several services and/or AI models. It follows that AI module 213 and/or processor 212 may be used to perform one or more of the operations in method 300 below.

Furthermore, the AI module 213 and/or processor 212 may include one or more machine learning models that have been developed from the foundation model. In other words, the foundation model provides a general understanding of the system in response to evaluating the system log information. The foundation model may thereby be used as a foundation on which more focused (e.g., tailored) machine learning models may be developed to perform more specific or detailed tasks, e.g., as would be appreciated by one skilled in the art after reading the present description.

With continued reference to FIG. 2A, edge nodes 204, 206 are depicted as having similar configurations, which is in no way intended to be limiting. In other approaches, edge nodes 204, 206 may have similar or different configurations. As shown, edge nodes 204, 206 each include a controller 217 coupled to memory 218. The edge node 204 may receive inputs from, and interface with, user 205, while edge node 206 may receive inputs from, and interface with, administrator 207. For instance, the user 205 and/or administrator 207 may input information using one or more of: a display screen 224, keys of a computer keyboard 226, and a computer mouse 228 of the respective edge node 204, 206. These inputs typically correspond to information presented on the display screen 224 while the entries were received. Moreover, the inputs received from the keyboard 226 and computer mouse 228 may impact the information shown on display screen 224, data stored in memory 218, information collected from network 210, status of an operating system being implemented by controller 217, etc.

Additionally, the controller 217 is coupled to an AI module 238 in both edge nodes 204, 206. As described above with respect to AI module 213, the AI module 238 may include any desired number and/or type of machine learning models. It follows that AI module 238 may implement similar, the same, or different characteristics as AI module 213 in central server 202. For instance, AI module 238 and/or controller 217 in edge node 204 and/or edge node 206 may be used to perform one or more of the operations in method 300 below.

Looking now to FIG. 2B, a distributed system 250 configured to orchestrate AI model (e.g., foundation model) deployment on resource-constrained edge devices 252A, . . . , 252N. In other words, the distributed system 250 provide orchestration techniques that are able to dynamically manage multi-objective, resource-dependent foundation model deployments, while also ensuring efficient utilization and optimal performance for scenarios that involve the co-existence of several services and/or AI models.

As shown, each of the edge devices 252A, . . . , 252N include a number of deployed (e.g., existing) AI models Model A, Model B, Model C, Model D, Model E, Model F. Edge devices 252A, 252N are also shown as requesting new AI model deployments Model G, Model H, respectively. The edge devices 252A, 252N may initially determine decisions 253A, 253N whether either of the respective requested AI models Model G, Model H involve a resource aware re-deployment of existing models. In other words, each decision 253A, 253N determines whether a sufficient number of resources are available (e.g., at each of the respective edge devices 252A, 252N) to form the newly requested AI models Model G, Model H. In response to determining sufficient available resources exist, the new AI model may simply be formed (e.g., deployed) at the respective edge device 252A, . . . , 252N. However, in response to determining sufficient available resources does not exist, the request for the new AI model may be sent to the AI model provisioning instance 254.

Each of the edge device 252A, . . . , 252N are connected to an AI model provisioning instance 254. For instance, edge device 252A includes a number of hardware components 256A (e.g., resources) that are configured to provide a virtualized infrastructure “Inf Virtualization,” along with an elastic infrastructure “Elastic Infra.” Similarly, edge device 252N includes a number of resources 256N that have been combined to provide a virtualized infrastructure “Inf Virtualization,” along with an edge computing “Edge Computing.”

Provisioning instance 254 is shown as orchestrating a process 270 that may be performed in order to ensure efficient AI model (e.g., foundation model) deployment. For instance, the operations performed in process 270 may utilize any of the available network resources (e.g., cloud computing capabilities) 279. As previously mentioned, this is particularly desirable for distributed systems that are connected to locations with limited resources, e.g., such as on edge nodes.

For instance, provisioning instance 254 is shown as sending various performance metrics 271 to operation 272 of process 270. The performance metrics 271 may include model hierarchies, minimum and/or maximum acceptable performance metrics, capacity profiling, etc., or any other available information depending on the approach. Operation 272 thereby includes using the received performance metrics to conduct model priority, performance, and state (PPS) profiling. In other words, operation 272 includes gathering the performance metrics and other information that provide insight as to the current state of AI model deployments at various customer locations. The current state of an AI model deployment may further be expressed in terms of priority compared to other model deployments, performance bounds, resource utilizations, etc. In some approaches, the amount and/or type of performance metrics received from provisioning instance 254 may impact how the current state of one or more AI model deployments are expressed.

In some approaches, operation 272 includes gathering potentially available information about qualitative or quantitative priority hierarchy (e.g., Model A>Model B) and/or expected model performances (e.g., minimum predicted accuracy, etc.). Moreover, a data collection and profile monitoring step may allow for essential resources, e.g., like CPU throughput, RAM capacity, etc., or other real-time metrics, to be collected. For instance, in other approaches, AI model metrics such as inference time, throughput, accuracy, etc. may be monitored.

Moreover, a holistic AI model and state profiling may be achieved by employing AI-driven analysis to infer future workloads based on data and/or AI model deployment. This may be implemented in some approaches using a data-preprocessing pipeline that includes normalization of metrics and feature engineering. In some approaches, profile generation is implemented. In still other approaches, the holistic AI model and state profiling is achieved by using clustering algorithms, e.g., such as K-means or DBSCAN to categorize potential AI models based on their performance metrics and resource utilization. Some approaches may evaluate LSTM/Transformer models to infer profiles and workloads based on historical data. Some approaches may even implement decision trees (e.g., such as Random Forests) to determine and/or verify model priorities, e.g., based on their performance metrics and real world impacts (resource use). It is preferred that approaches employ feedback mechanisms to constantly update the priority list for the AI models based on changing conditions and real world demand. Some approaches may be implemented as a dynamic priority adjustment via real-time monitoring such that model performance metrics and resource utilization may continuously monitored.

Some approaches may also implement AI powered decision making by implementing reinforcement learning agents that adaptively adjust model priorities based on real-time feedback. Over time, these agents can thereby learn the optimal priority assignments based on historical performance and resource constraints. Threshold-based adjustments may also be made to define clear thresholds for model performance metrics (e.g., like accuracy or latency). In situations where an AI model consistently underperforms or overutilizes resources beyond these thresholds, approaches may automatically adjust the model's corresponding priority down. Conversely, in situations where a model consistently outperforms expectations, its priority may be elevated.

Further still, model retraining may be performed based on any feedback received and/or historical data collected. This information may be used to periodically retrain AI models used in a profile generation phase to improve accuracy and relevance of the resulting models. Automated testing may also be used to implement automated testing procedures which evaluate the effectiveness of priority adjustments. For example, after adjusting priorities, how these changes impact overall system performance and resource utilization may be monitored. The feedback mechanism may even be redefined in some approaches based on these test results, e.g., as would be appreciated by one skilled in the art after reading the present description.

With continued reference to FIG. 2B, the provisioning instance 254 also sends information 273 corresponding to newly requested AI models to operation 274. The information 273 that is sent may include any desired specifications, predicted resource consumption, preferred hierarchy standings, etc., of the newly requested AI model. There, operation 274 includes using the received information to determine the appropriate resource (e.g., capacity) utilization that should be allotted to the newly requested AI model. Resource utilizations are also preferably compared against resources being used to satisfy existing workloads. It follows that in some situations, resources used by existing AI model deployments may be re-configured and re-deployed along with available resources in order to satisfy the newly requested AI model.

Accordingly, approaches herein are able to achieve holistic AI model deployment trade-off by employing predictive analysis to infer future resource usage based on past data and model deployments. In some approaches, this may be implemented using time-series analysis or forecasting models. In other approaches, this may be accomplished implementing a performance metric analysis via profiling the incoming AI model to understand the associated resources and predicted performance metrics. Benchmarking this profile against the profiles of currently deployed models may further develop an understanding for possible trade-offs. Some approaches employ decision-making mechanisms to determine the feasibility of new AI model deployments. For instance, decision-making mechanisms may be implemented as rule-based decisions based on predefined performance and/or resource thresholds. Some approaches may use a voting system, e.g., particularly in complex multi-model deployments, where each model or its representative agent “votes” based on its relative priority and importance. Alternatively, reinforcement learning agents may be used. The reinforcement learning agents may state current resource usage, model requests, and performance metrics of deployed models. The reinforcement learning agents may also deploy, compress, and/or or deny requested AI models. Further still, reinforcement learning agents may reward certain options based on successful deployments, maintained performance guarantees, efficient resource utilization, etc.

Exploring re-configuration and compression possibilities for existing AI models may use model compression techniques like quantization, pruning, knowledge distillation, etc. Approaches may also be able to dynamically adjust which existing models can be offloaded, paused, or replaced with compressed versions (e.g., to reduce storage size). Some approaches employ a feedback and iteration mechanism post-deployment to understand the effectiveness of the trade-off decisions. The mechanism may continuously monitor the performance of the newly deployed AI model and periodically update the profiles of models based on real-world performance experienced at the edge devices. Furthermore, trade-off decisions and updated model profiles may be stored in a dedicated database for quick retrieval and future decision-making.

Proceeding from operation 274 to operation 276, there operation 276 includes creating the newly requested AI model. In some approaches, the newly requested AI model may be formed using available resources. Thus, operation 276 may include simply configuring a desired combination of available resources, and deploying the desired combination, thereby creating the requested AI model. In other approaches, operation 276 includes simply re-implementing one or more AI models that are stored in a database 277. The database 277 may outline previous deployments of resources, e.g., such that known relationships between compiled resources may be used to satisfy newly received requests. Similarly, the provisioning instance 254 is shown as having access to another database 255 that may be used to store various foundation models.

In still other approaches, operation 276 includes dynamically re-configuring one or more existing AI model deployments, such that the resources may be combined differently such that existing AI model deployments may be maintained while also creating the newly requested AI model. For example, in situations where there are insufficient available resources to create a new AI model, one or more existing AI model deployments may be compressed, such that at least some of the resources utilized by the uncompressed one or more existing AI model deployments become available.

It follows that operation 276 includes determining which existing model(s) should be re-configured or replaced, e.g., based on the trade-off decisions made in operation 274 above. In some approaches, the models that are currently deployed are assessed to determine whether any can be re-configured or replaced. The assessment may analyze the performance metrics and resource utilization of each model, comparing it against the pareto-optimal benchmarks from a standard taken as an input. Model compression techniques that may be implemented apply direct compression techniques—e.g., such as quantization (reducing the precision of the numbers representing the model's parameters), pruning (removing certain parts of the model, like neurons or entire layers, that have minimal impact on performance), knowledge distillation (training a smaller model to imitate the behavior of a larger model), etc. These methods may be applied in situations where prior knowledge is available, e.g., due to open-source model benchmarks, research, etc. Alternatively, a compressed model may be formed based on the currently available and associated capacity. The compressed model may further be benchmarked against the original model to ensure performance metrics are within acceptable limits.

Dynamic re-deployment of resources as described herein may use orchestration tools, e.g., such as Kubernetes™ to seamlessly replace a current model deployment with a compressed version. This desirably ensures that the transition is smooth, with minimal downtime and service disruption. After re-deployment, the freed resources are preferably redistributed to accommodate other models or system processes. Resource utilization is also preferably monitored to ensure optimal performance and prevent potential bottlenecks. This is particularly true following the re-deployment of a compressed AI model, where performance of the compressed model may be continuously monitored to ensure it meets expected metrics. If any anomalies or performance drops are detected, further refinements may be performed and/or the compressed model may be reverted to a previous configuration.

The compressed one or more existing AI models may thereby be re-deployed 275 along with a new AI model created using the freed resources and/or other available resources. The AI models are ultimately deployed (or re-deployed) at the respective edge devices 252A, . . . , 252N, e.g., depending on where AI model requests are received from. Furthermore, operation 278 includes performing AI model hosting. In other words, operation 278 includes storing certain AI models that have been (or are currently) deployed on one or more of the edge devices 252A, . . . 252N. This allows for details associated with previously implemented AI models, e.g., such as the specific combination of resources used to form the AI models, to be retained. This allows for AI models to be easily re-deployed even after they have been removed from the edge devices 252A, . . . , 252N. For example, operation 278 may store a copy of the details associated with previously implemented AI models in database 277.

In some approaches, operation 278 includes identifying which existing AI models to offload from an edge device, while ensuring the removal aligns with any decisions made regarding resource optimization. For instance, model identification and selection may be used to evaluate a list of models generated by a model configured to identify models that should be offloaded. Models selected for offloading may be inspected to ensure they are not actively in use or temporarily paused while in use. Steps may also be taken to ensure that the capacity gains are relevant to other services (e.g., via previous capacity estimations and/or workload predictions).

Selected models and their respective parameters are thereby converted into a format suitable for storage, e.g., such as ONNX or TensorFlow's SavedModel format. This desirably ensures each model retains its structure and can be re-deployed without loss of information. The selected models are also preferably transmitted securely. For instance, a secure connection may be established between an edge device and a central server, and encryption methods, e.g., such as Transport Layer Security (TLS), may be used to ensure the models and corresponding data is securely transmitted without risks of interception or tampering. The serialized model may further be stored, thereby ensuring it is categorized and indexed appropriately. Metadata tagging may also be used to capture additional details, e.g., like model version, date of offloading, associated performance metrics, etc.

Following the offloading of resources, the freed-up resources on the edge device may be redistributed to satisfy other workloads and/or requested processes. It follows that a central server may implement a retrieval system that allows for quick and efficient re-deployment of the offloaded models when desired. It is also desirable that the retrieval process accounts for model dependencies and/or auxiliary files associated with operating the given model. Approaches also preferably monitor the health and integrity of offloaded models. Approaches periodically check for updates or optimizations that can be applied to any of the stored AI models, ensuring they remain relevant and efficient for future deployments.

Looking now to FIG. 2C, an alternate view of a process 280 that may be performed in order to ensure efficient AI model (e.g., foundation model) deployment is illustrated in accordance with one approach. It follows that one or more of the operations in process 280 may be implemented in combination with process 270 and/or system 200 as a whole, e.g., as would be appreciated by one skilled in the art after reading the present description.

As shown, edge node 281 includes Existing AI Models that are currently deployed. Edge node 281 also includes components that are configured to allow for the edge node 281 to communicate with a central server 283 that is configured to dynamically manage multi-objective, resource-dependent AI model deployments, while also ensuring efficient utilization and optimal performance for scenarios that involve the co-existence of several services and/or AI models.

Accordingly, operation 282 includes receiving an AI model request at the central server 283 from the edge node 281. The AI model request corresponds to a New AI Model Deployment that is desired at the edge node 281. The AI model request may thereby also include supplemental information, e.g., such as metadata, configuration information, AI model and/or service hierarchy information, etc., that corresponds to the AI model being requested. Proceeding to operation 284, Model PPS profiling is performed on the received request and/or supplemental information. For example, operation 284 may include evaluating capacity profiling requests and/or any model priority (e.g., hierarchy) information that may be received from the edge node 281.

From operation 284, process 280 advances to operation 285 where any received information is used to determine the appropriate resource utilization that most desirably (e.g., efficiently) satisfies the new AI model request. Resource utilizations are also preferably compared against resources being used to satisfy existing workloads. It follows that in some situations, resources used by existing AI model deployments may be re-configured and re-deployed along with available resources in order to satisfy the newly requested AI model.

Accordingly, operation 286 includes dynamically configuring and deploying AI models as determined in operation 285. In some approaches, the newly requested AI model may be formed using available resources. Thus, operation 286 may include simply configuring a desired combination of available resources, and deploying the desired combination, thereby creating the requested AI model. In other approaches, operation 286 includes simply re-implementing one or more AI models that are stored in a database 287. The database 287 may outline previous deployments of resources, e.g., such that known relationships between compiled resources may be used to satisfy newly received requests. In some approaches, the database 287 implements a resource aware AI model deployment strategy that may be configured to provide AI model variants that are more easily re-deployable, e.g., based on the current states of the various resources. Similarly, operation 285 is shown as providing information to operation 289 below, which may be stored in database 290 depending on the approach.

From operation 286, process 280 advances to operation 288 where new resource provisioning is implemented at the edge node 281 such that the New AI Model Deployment is implemented at the edge node 281. It should also be noted that the determined resource utilizations and or existing resource utilizations may be stored in memory, e.g., for future access.

Accordingly, process 280 may advance from operation 285 directly to operation 289. There, operation 289 includes performing AI model hosting. In other words, operation 289 includes storing, e.g., in database 290, certain AI models that have been (or are currently) deployed on the edge node 281. This allows for details associated with previously implemented AI models, e.g., such as the specific combination of resources used to form the AI models, to be retained. This allows for AI models to be easily re-deployed even after they have been removed from the edge node 281.

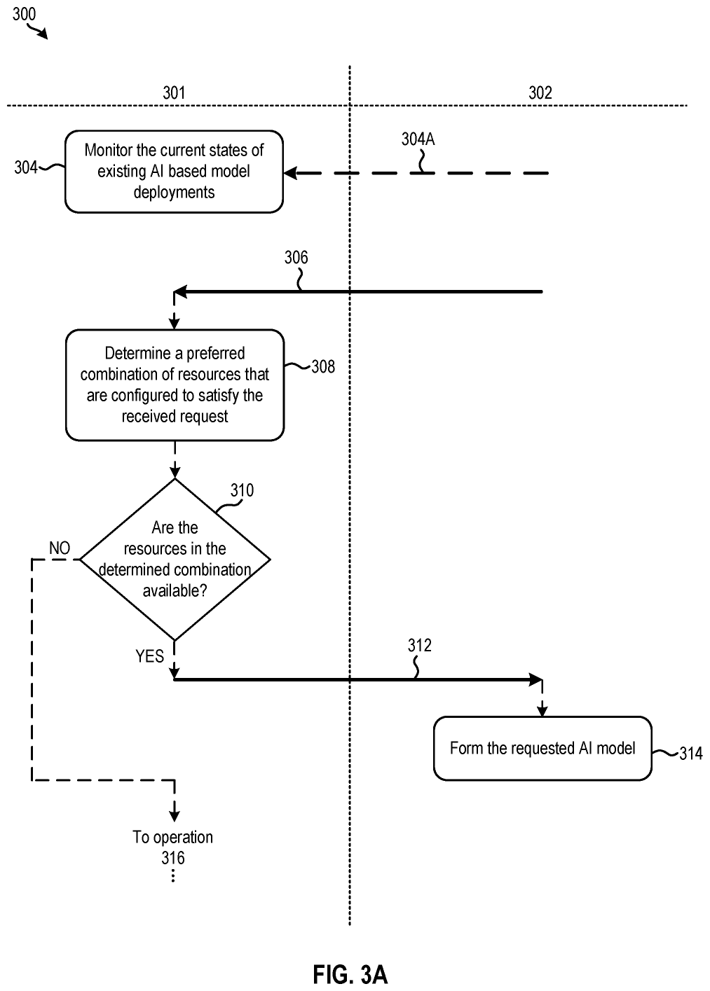

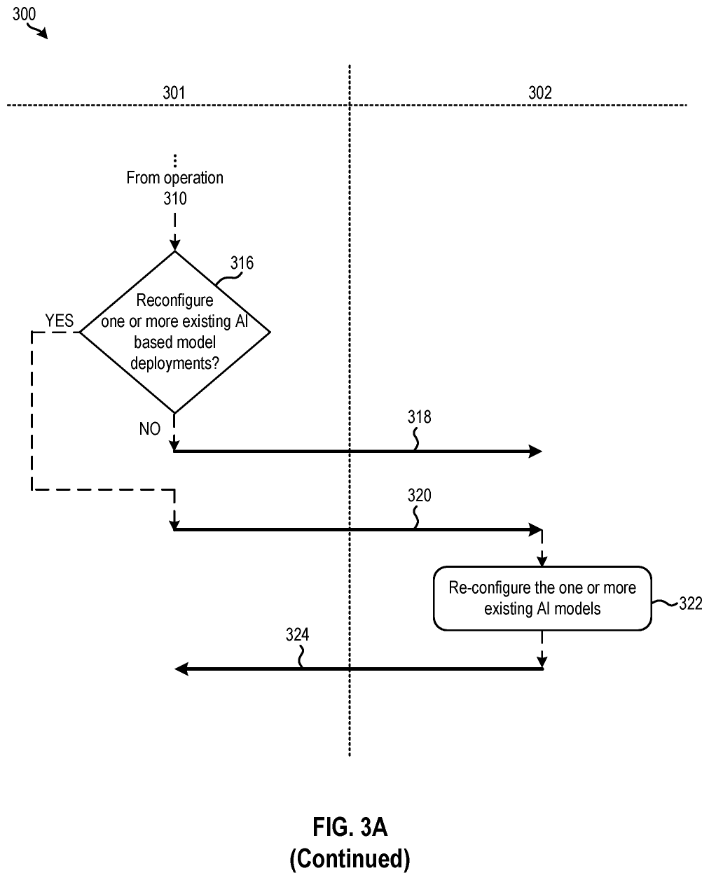

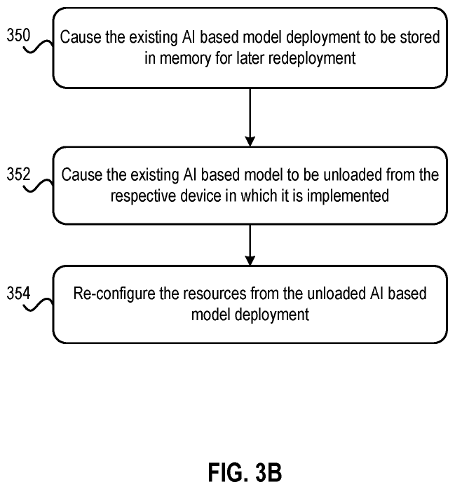

Looking now to FIG. 3A, a flowchart of a computer-implemented method 300 for orchestrating AI model (e.g., foundation model) deployment across various devices. Method 300 is thereby able to provide orchestration techniques that can dynamically manage multi-objective, resource-dependent foundation model deployments, while also ensuring efficient utilization and optimal performance for scenarios that involve the co-existence of several services and/or AI models.

Method 300 may be performed in accordance with the present invention in any of the environments depicted in FIGS. 1-2C, among others, in various approaches. Of course, more or less operations than those specifically described in FIG. 3A may be included in method 300, as would be understood by one of skill in the art upon reading the present descriptions. Each of the operations in method 300 may further be performed by any suitable component of the operating environment. For example, the nodes 301, 302 shown in the flowchart of method 300 may correspond to one or more processors positioned at a different location in a distributed system. Moreover, each of the one or more processors are preferably configured to communicate with each other.

In various approaches, the method 300 may be partially or entirely performed by a controller, a processor, etc., or some other device having one or more processors therein. The processor, e.g., processing circuit(s), chip(s), and/or module(s) implemented in hardware and/or software, and preferably having at least one hardware component may be utilized in any device to perform one or more steps of the method 300. Illustrative processors include, but are not limited to, a central processing unit (CPU), an application specific integrated circuit (ASIC), a field programmable gate array (FPGA), etc., combinations thereof, or any other suitable computing device known in the art.

As mentioned above, FIG. 3A includes different nodes 301, 302, each of which represent one or more processors, controllers, computer, etc., positioned at a different location in a distributed system. Node 301 may include one or more processors which are located at a central server of a distributed system (e.g., see processor 212 of FIG. 2A above). In another approach, node 301 may include one or more processors which are located at a provisioning instance of a distributed system (e.g., see provisioning instance 254 of FIG. 2B above). In another approach, node 302 may include one or more processors which are located at an edge node that is connected to a network in a distributed system (e.g., see controller 217 of FIG. 2A above). In still another approach, node 302 may include one or more processors which are located at one or more of the edge nodes connected to a network in a distributed system (e.g., see edge devices 252A, . . . , 252N of FIG. 2B above). Accordingly, commands, code, data, metadata outlining code updates, etc. may be sent between the nodes 301, 302 depending on the approach. It should also be noted that the various processes included in method 300 are in no way intended to be limiting, e.g., as would be appreciated by one skilled in the art after reading the present description. For instance, data sent from node 302 to node 301 may be prefaced by a request sent from node 301 to node 302 in some approaches.

As shown, operation 304 is performed at node 301. There, operation 304 includes monitoring the current states of existing AI based model deployments. In other words, operation 304 includes inspecting various existing AI models deployed at node 302 and/or elsewhere, and evaluating performance of the models. Performance of the models may be evaluated using information about current state of model deployments, their priorities, performance bounds, resource utilizations, etc., to output a current state corresponding to a network with a plurality of edge devices and AI models deployed on said devices. It should be noted that as used herein, an “AI based model” or “AI model” may include any desired number and/or type of AI model(s). In some approaches, AI based model deployments include multi-objective foundation models, but may include deep neural networks, machine learning models, etc.

In some approaches, evaluation performed in operation 304 may be based at least in part on performance information that is received at node 301. See operation 304A. In other words, operation 304A includes gathering information associated with the current states of existing AI based models deployed at node 302. It follows that node 301 may receive performance information from node 302 over time, allowing node 301 to monitor performance of the AI models that have been deployed. For instance, in some approaches operation 304 includes using any information associated with the current states of the AI based model deployments that may be received from node 302, e.g., to perform capacity profiling at node 301. In some approaches, performing capacity profiling outputs a prioritized list of the AI based model deployments and their respective current states. Thus, the evaluation performed in operation 304 may produce a prioritized list of currently deployed AI based models and their respective current states. Node 301 is thereby able to maintain an accurate understanding of how each AI model is performing, which is particularly useful while re-configuring existing models to facilitate newly requested AI models.

Existing AI model deployments and/or available resources may continue to be monitored over time. This allows method 300 to identify any issues that may arise during operation. However, method 300 advances from operation 304 in response to receiving a request. For example, node 302 is shown as sending a request to node 301 for a specific AI model. See operation 306. The request may be initiated at node 301 in response to a workload being received, one or more existing AI models going offline, running application outputting a result, a predetermined condition being met, etc.

In response to receiving the request for a new AI based model deployment at node 301, method 300 advances to operation 308. There, operation 308 includes determining a preferred combination of resources that are configured to satisfy the received request. In other words, operation 308 includes using any known (e.g., received) information associated with existing AI model deployments and/or a requested AI model, to determine the appropriate resource (e.g., capacity) utilization that should be allotted to the newly requested AI model. With respect to the present description, the “preferred combination of resources” preferably includes the combination of identifiable resources that accomplishes a given request most efficiently. However, the “preferred combination of resources” may differ depending on the approach. For instance, some approaches may value combinations of resources that are available without re-configuring one or more existing deployments. Resource utilizations are also preferably compared against resources being used to satisfy existing workloads. It follows that in some situations, resources used by existing AI model deployments may be re-configured and re-deployed along with available resources in order to satisfy the newly requested AI model.

Thus, operation 308 may include configuring a desired combination of available resources, and cause the desired combination to be deployed, thereby creating the requested AI model. In some approaches, operation 308 includes simply re-implementing one or more AI models that are stored in a database that outlines previous deployments of resources, e.g., such that known relationships between compiled resources may be used to satisfy newly received requests. In some approaches, operation 308 may include dynamically re-configuring one or more existing AI model deployments, such that the resources may be combined differently to maintain existing AI model deployments while also creating the newly requested AI model. For example, in situations where there are insufficient available resources to create a new AI model, one or more existing AI model deployments may be compressed, such that at least some of the resources utilized by the uncompressed one or more existing AI model deployments become available. It follows that the desired combination of available resources may be configured (e.g., determined) in operation 308 using any one or more of the approaches herein (e.g., see FIGS. 2A-2C).

With continued reference to FIG. 3A, method 300 advances from operation 308 to operation 310. There, operation 310 includes determining whether the resources in the combination determined in operation 308 are currently available. In other words, operation 310 determines whether all of the resources identified as being capable of forming the requested AI model are available or currently deployed in a different AI model. This determination may be made by accessing a lookup table that stores which resources are currently in use, inspecting each of the resources themselves, sending requests to devices (e.g., edge nodes) that include the resources, etc.

In response to determining that the resources in the combination determined in operation 308 are currently available, method 300 advances to operation 312. There, operation 312 includes causing the combination of available resources to be deployed. In other words, operation 312 includes causing the available resources at node 302 to be combined and deployed, thereby forming the requested AI model at node 302. See operation 314.

However, method 300 advances to operation 316 in response to determining that one or more of the resources in the combination are currently unavailable. There, operation 316 includes determining whether to re-configure resources used to form one or more of the existing AI based model deployments to satisfy the received request. In other words, operation 316 includes determining whether any existing AI models may be removed and/or redeployed in a different configuration in an attempt to free resources currently being used. Different factors may be taken into consideration to perform the determination in operation 316. For example, the relative importance, security profile, predetermined settings, etc., of an AI model may be taken into consideration while determining whether it should be re-configured to introduce a new AI model. Relative abundance of each resource may also be taken into consideration. For example, a scarce resource may be given a greater weight than resources that have more duplicates and/or alternatives.

In response to determining that one or more of the existing AI based model deployments should not be re-configured to satisfy the received request, method 300 advances from operation 316 to operation 318. In other words, method 300 advances to operation 318 in response to determining that the resources associated with forming the requested AI model are currently unavailable. There, operation 318 includes denying the received AI model request. In some approaches, information outlining the unavailable resources, alternative AI models that are currently supported, a suggested wait time before reissuing the same AI model request, etc., may be sent to requesting node 302 in operation 318.

Returning to operation 316, method 300 alternatively proceeds to operation 320 in response to determining that one or more of the existing AI based model deployments can be re-configured to satisfy the received request. In other words, method 300 advances to operation 320 in response to determining that the resources associated with forming the requested AI model may be made available. There, operation 320 includes causing the resources used to form one or more of the existing AI based model deployments to be re-configured. In some approaches, operation 320 involves sending one or more instructions, commands, requests, etc., to node 302 that result in (e.g., cause) node 302 re-configuring one or more existing AI models. Accordingly, operation 322 includes node 302 re-configuring the one or more existing AI models as outlined in the information received in operation 320. As noted above, the one or more existing AI models are preferably re-configured such that updated versions of the one or more existing AI based model deployments are formed, in addition to the requested new AI based model deployment.

According to a non-limiting example, operation 322 may include compressing one or more existing AI models. The compressed AI models may thereby be re-deployed at node 302, along with a new AI model created using the freed resources and/or other available resources at node 302. Furthermore, operation 324 includes performing AI model hosting. In other words, operation 324 includes storing certain AI models that have been (or are currently) deployed at node 302. This allows for details associated with previously implemented AI models, e.g., such as the specific combination of resources used to form the AI models, to be retained. AI models may thereby be easily re-deployed even after they have been removed from an edge device.

Referring momentarily now to FIG. 3B, exemplary sub-operations of causing resources used to form an existing AI based model deployment to be re-configured are illustrated in accordance with one approach. It follows that one or more of these sub-operations may be used to perform operation 320 and/or operations 322, 324 (e.g., in response to one or more instructions received in operation 320) of FIG. 3A. However, it should be noted that the sub-operations of FIG. 3B are illustrated in accordance with one approach which is in no way intended to be limiting.

As shown, sub-operation 350 includes causing the existing AI based model deployment to be stored in memory for later redeployment. As noted above, existing AI based model deployments are preferably stored in memory such that the same or similar combinations of resources may be combined at a later point to form a known (e.g., previously formed) AI model. In some approaches, storing an existing AI model deployment includes storing running parameters of the respective deployment. Moreover, by storing performance characteristics, the known AI model may perform as expected once formed, thereby improving the ability of method 300 to efficiently satisfy incoming AI model requests. This is particularly true in approaches implementing foundation models and/or other complex AI models.

From sub-operation 350, the flowchart proceeds to sub-operation 352. There, sub-operation 352 includes causing the existing AI based model to be unloaded from the device in which it is implemented. In other words, sub-operation 352 includes unassigning any resources used to form the existing AI based model. This effectively changes the various resources from being unavailable (e.g., currently deployed) to being available for deployment.

In response to unloading the one or more existing AI based model deployments, the flowchart proceeds to sub-operation 354. There, sub-operation 354 includes actually re-configuring the resources from the unloaded AI based model deployment. The resources that are freed from the AI based model deployment after it has been unloaded may be able to form the desired AI model in some approaches. In other approaches, the freed resources may be combined with other available resources to form the desired AI model. Moreover, the desired AI model is preferably formed along with an updated version of the existing AI based model that was reconfigured to allow the new AI model to be formed.

It follows that approaches herein are able to overcome conventional issues by desirably ensuring dynamic resource allocation and model prioritization. For instance, approaches herein are desirably able to maintain dynamic multi-objective management by profiling current AI model deployments; and evaluating the priorities, performance metrics, and resource usage. This allows for dynamic adjustments in model configurations to meet varying objectives in an efficient manner, which has been conventionally unachievable. Approaches herein are also able to achieve resource dependent deployment strategies which evaluate the trade-offs between deploying AI models (e.g., foundation models), considering existing workloads and performance criteria. This desirably ensures efficient use of limited resources on edge devices.

Further still, approaches herein are able to achieve real-time model reconfigurations by dynamically redeploying re-configured (improved) AI configurations, allowing for swift model swapping and resource reallocation, which is particularly desirable in time-sensitive operations. Approaches herein also achieve model preservation and quick redeployment by offloading models which are preserved for future use and can be quickly redeployed, maintaining operational continuity.

Approaches herein are desirably able to adapt to changing conditions by utilizing AI-driven analysis. Thus, approaches are able to infer future workloads and adjust priorities based on real-time data, ensuring consistent performance and resource efficiency. Moreover, advanced procedures of computing pareto-optimal capacity-performance curves for various model specifications are achieved herein, thereby streamlining the decision-making process in dynamic edge applications.

Approaches herein are thereby able to accomplish a network in which clients request and deploy a pre-trained (or fine-tuned) AI model (e.g., foundation model) at their respective edge networks. In such configurations, network may select and provision a new AI model based on a client's capacity specifications. However, the client may request multiple models to be deployed with dedicated capacity allocations for specific use cases and models, respectively. Approaches herein are thereby able to evaluate and weigh a number of factors, including: how to request and deploy an AI model (or compressed version of it) with limited capacity specifications, how to determine and dynamically re-schedule previously used capacities for new model deployments, how to assign priorities for certain AI models that are currently running on-devices, how to determine and initiate re-deployments of smaller AI models to free up capacities for new AI models (particularly for current models having non-essential or low priorities).

Approaches herein are also able to identify continuous pareto-optimal decision curves for capacity dependent AI model deployments. For instance, approaches are able to ensure an efficient computation of pareto-optimal capacity-performance curves for several different compressed, pruned, or altered AI model specifications. As a result, those model architectures are not extensively searched, but can rather be quickly inferred for dynamic edge applications with varying capacity specifications, e.g., as would be appreciated by one skilled in the art after reading the present description.

It will be clear that the various features of the foregoing systems and/or methodologies may be combined in any way, creating a plurality of combinations from the descriptions presented above.

It will be further appreciated that implementations of the present invention may be provided in the form of a service deployed on behalf of a customer to offer service on demand.

The descriptions of the various implementations of the present invention have been presented for purposes of illustration, but are not intended to be exhaustive or limited to the implementations disclosed. Many modifications and variations will be apparent to those of ordinary skill in the art without departing from the scope and spirit of the described implementations. The terminology used herein was chosen to best explain the principles of the implementations, the practical application or technical improvement over technologies found in the marketplace, or to enable others of ordinary skill in the art to understand the implementations disclosed herein.

What is claimed is:

1. A computer-implemented method (CIM), comprising:
receiving a request for a new AI based model deployment;
determining a combination of resources that are configured to satisfy the received request;
in response to determining that at least one of the resources in the combination of resources is unavailable, determining whether to re-configure resources used to form one or more existing AI based model deployments to satisfy the received request;
causing the resources used to form the one or more existing AI based model deployments to be re-configured; and
re-deploying the re-configured resources, by:
causing updated versions of the one or more existing AI based model deployments to be formed, and
causing the requested new AI based model deployment to be formed.

2. The CIM of claim 1, wherein the updated versions of the one or more existing AI based model deployments are formed by:
compressing the resources used to form the one or more existing AI based model deployments; and
compressing the combination of resources configured to satisfy the received request.

3. The CIM of claim 1, further comprising:
monitoring current states of the existing AI based model deployments by:
gathering information associated with the current states of the existing AI based model deployments; and
using the information to perform capacity profiling.

4. The CIM of claim 3, wherein the information associated with the current states of the existing AI based model deployments is selected from the group consisting of:
priority information, performance bounds, and resource utilizations.

5. The CIM of claim 3, wherein the using of the information to perform capacity profiling includes:
outputting a prioritized list of the existing AI based model deployments and their respective current states.

6. The CIM of claim 1, wherein the causing of the resources used to form the one or more existing AI based model deployments to be re-configured includes:
causing the one or more existing AI based model deployments to be stored in memory;
causing the one or more existing AI based model deployments to be unloaded; and
re-configuring the resources from the one or more unloaded AI based model deployments to form:
the updated versions of the one or more existing AI based model deployments, and
the requested new AI based model deployment.

7. The CIM of claim 6, wherein the causing of the one or more existing AI based model deployments to be stored in memory includes:
storing running parameters of the one or more existing AI based model deployments.

8. The CIM of claim 1, wherein one or more of the existing AI based model deployments include multi-objective foundation models on at least one edge device.

9. The CIM of claim 8, wherein the requested new AI based model deployment includes one or more multi-objective foundation models.

10. The CIM of claim 8, wherein the operations are performed by a central server connected to the at least one edge device.

11. A computer program product (CPP), comprising:
a set of one or more computer-readable storage media; and
program instructions, collectively stored in the set of one or more storage media, for causing a processor set to perform the following computer operations:
receive a request for a new AI based model deployment;
determine a combination of resources that are configured to satisfy the received request;
in response to determining that at least one of the resources in the combination of resources is unavailable, determine whether to re-configure resources used to form one or more existing AI based model deployments to satisfy the received request;
cause the resources used to form the one or more existing AI based model deployments to be re-configured; and
re-deploy the re-configured resources, by:
causing updated versions of the one or more existing AI based model deployments to be formed, and
causing the requested new AI based model deployment to be formed.

12. The CPP of claim 11, wherein the updated versions of the one or more existing AI based model deployments are formed by:
compressing the resources used to form the one or more existing AI based model deployments; and
compressing the combination of resources configured to satisfy the received request.

13. The CPP of claim 11, wherein the program instructions are for causing the processor set to further perform the following computer operations:
monitor current states of the existing AI based model deployments by:
gathering information associated with the current states of the existing AI based model deployments; and
using the information to perform capacity profiling.

14. The CPP of claim 13, wherein the information associated with the current states of the existing AI based model deployments is selected from the group consisting of: priority information, performance bounds, and resource utilizations.

15. The CPP of claim 13, wherein the using of the information to perform capacity profiling includes:
outputting a prioritized list of the existing AI based model deployments and their respective current states.

16. The CPP of claim 11, wherein the causing of the resources used to form the one or more existing AI based model deployments to be re-configured includes:
causing the one or more existing AI based model deployments to be stored in memory;
causing the one or more existing AI based model deployments to be unloaded; and
re-configuring the resources from the one or more unloaded AI based model deployments to form:
the updated versions of the one or more existing AI based model deployments, and
the requested new AI based model deployment.

17. The CPP of claim 16, wherein the causing of the one or more existing AI based model deployments to be stored in memory includes:
storing running parameters of the one or more existing AI based model deployments.

18. The CPP of claim 11, wherein one or more of the existing AI based model deployments include multi-objective foundation models on at least one edge device.

19. The CPP of claim 18, wherein the requested new AI based model deployment includes one or more multi-objective foundation models, wherein the operations are performed by a central server connected to the at least one edge device.

20. A computer system (CS), comprising:
a processor set;
a set of one or more computer-readable storage media;
program instructions, collectively stored in the set of one or more storage media, for causing the processor set to perform the following computer operations:
receive a request for a new AI based model deployment;
determine a combination of resources that are configured to satisfy the received request;
in response to determining that at least one of the resources in the combination of resources is unavailable, determine whether to re-configure resources used to form one or more existing AI based model deployments to satisfy the received request;
cause the resources used to form the one or more existing AI based model deployments to be re-configured; and
re-deploy the re-configured resources, by:
causing updated versions of the one or more existing AI based model deployments to be formed, and
causing the requested new AI based model deployment to be formed.
